(19) United States
(12) Patent Application Publication
(10) Pub. No.: US 2023/0282909 A1
(43) Pub. Date: Sep. 7, 2023

(54) Housing for a battery module for receiving battery cells

(71) Applicant: Webasto SE, Stockdorf (DE)

(72) Inventors: Mario Meyer, Stockdorf (DE); Jochen Haussmann, Stockdorf (DE)

(21) Appl. No.: 18/019,418

(22) PCT Filed: Aug. 4, 2021
(86) PCT No.: PCT/EP2021/071768

§ 371 Date: Feb. 2, 2023

(30) Foreign Application Priority Data
Aug. 4, 2020 (DE) 20 2020 104 503.2

(51) Int. Cl. H01M 50/103; H01M 50/242; H01M 50/262

(52) U.S. Cl. CPC H01M 50/103; H01M 50/242; H01M 50/262

(57) ABSTRACT

A housing for a battery module for receiving battery cells, comprising at least one end plate made up of an inner profile element and an outer profile element, where the inner profile element is formed and designed such that, within a first deformation path, it provides a first elastic bias on battery cells arranged in the housing, and where the inner profile element and the outer profile element are formed and designed such that, once the first deformation path is exceeded, the inner profile element interacts with the outer profile element to exert a second elastic bias on battery cells arranged in the housing.

### CROSS-REFERENCE TO RELATED APPLICATIONS

This application is a 35 U.S.C. §371 National Stage Entry of International Application No. PCT/EP2021/071768 filed Aug. 4, 2021, which claims the priority benefit of German Patent Application Serial Number DE 20 2020 104 503.2 filed Aug. 4, 2020, all of which are incorporated herein by reference in their entirety for all purposes.

### TECHNICAL FIELD

The present invention relates to a housing for a battery module for receiving battery cells. The present invention further relates to a traction battery for a motor vehicle, preferably for an automobile, a bus and/or a truck.

### BACKGROUND

When vehicles are electrified, it is important for the housing for the traction batteries installed in the vehicle to be optimized. In this respect, the greatest possible traction battery capacity should be reached, in order to provide a high range.

This normally involves battery cells being combined in a housing for a battery module. Multiple battery cells are normally mounted in the housing and electrically connected to one another.

Furthermore, it is desirable for the functionality, capacity and life of the battery cells installed in the battery module to be improved. In this case, it is known in the art for swelling forces to arise during the charging/discharging of battery cells, said swelling forces leading to what is referred to as a “breathing of the cell”. In other words, the battery cells can swell and go down during charging and discharging. In addition, a continuous increase in size can occur over the life of the cells.

This can be seen particularly in prismatic cells and in pouch cells. In the case of prismatic cells, it must also be ensured that the swelling forces do not destroy the thin casings of the cells. Therefore, prismatic cells are frequently installed in fixed housings which limit the swelling of the cells and therefore prevent the cell membranes from rupturing.

Accordingly, it is known in the art for battery cells to be provided in a housing with a rigid end plate in each case, in order to clamp the battery cells of the battery module. However, the disadvantage of this is that the swelling forces of the cells are not optimally absorbed, since the battery cell is unable to expand or “breathe”. This means that the forces become ever-greater over the life in the battery cells of the battery module.This may result in the functionality of the battery cells being adversely affected, in particular in a reduced capacity and/or life.

### SUMMARY OF THE INVENTION

Based on the known prior art, an object addressed by the present invention is to provide an improved solution for a housing for a battery module which improves the capacity and life of the battery cells.

This object is solved by a housing for a battery module for receiving battery cells which has the features of claim 1. Advantageous developments result from the dependent claims, the present description, and the figures.

Accordingly, a housing for a battery module for receiving battery cells is proposed, which housing comprises at least one end plate made up of an inner profile element and an outer profile element, wherein the inner profile element is formed and designed such that, within a first deformation path, it provides a first elastic bias on battery cells arranged in the housing, and wherein the inner profile element and the outer profile element are formed and designed such that, once the first deformation path is exceeded, the inner profile element interacts with the outer profile element to exert a second elastic bias on battery cells arranged in the housing.

By means of the two-part solution made up of the inner profile element and the outer profile element of the at least one end plate, the rigidity of the end plate, and therefore a desired bias on the battery cells, can be better adjusted depending an expansion of the battery cells. Until a first deformation path is reached, the bias on the battery cells is set accordingly via the inner profile element.

Once the first deformation path is exceeded, the inner and the outer profile element interact in such a way that the rigidity of the end plate is increased. Accordingly, a second bias acts on the battery cells in this region. The bias acting on the battery cells is therefore adjusted in two stages in an optimized manner, at least by the two-part solution. In other words, the battery cells can expand while maintaining a bias. The functionality of the battery cells is thereby improved and the life of the battery module lengthened.

Furthermore, the two-part solution can define an individual and desired ratio of bias to the expansion of the battery cell, which can be adapted to the specific installed cell requirement.

The housing preferably has, on the two end sides, an end plate according to the invention, which are formed opposite one another. In other words, the battery cells are clamped between the two end plates. The battery cells are thus biased or clamped by the opposite end plates with a desired bias in order to ensure an improved mode of operation.

In this case, the deformation path describes the expansion of the inner profile element and of the outer profile element in a direction perpendicular to the plane defined by the end plate. During operation, the deformation path in this case corresponds to the expansion of the battery cells in the longitudinal direction of the battery module in the direction of the end plates.

The bias denotes a bias which the end plate applies to the battery cells. In this case, the battery cells are biased in an initial state, i.e. in a first installed state in the housing, preferably with a bias F0. In the further course, the swelling forces of the battery cells occurring during operation of the battery module, which cause an expansion of the battery cells in the longitudinal direction of the battery module, are absorbed by the end plate in such a way that the expansion of the battery cells is absorbed, but in this case a desired bias furthermore acts on the battery cells, wherein a bias which is critical for the capacity of the battery cell is not exceeded.

By virtue of the shape and configuration of the end plate, in particular of the inner profile element and of the outer profile element, a desired bias curve can be defined as a function of the expansion of the battery cells. Due to the two-part design of the end plate, i.e. with an inner profile element and an outer profile element, different bias curves can be configured. In this way, a housing for a wide variety of battery module configurations can be provided in a simple and flexible manner.

According to a preferred embodiment, the inner profile element and the outer profile element interact in such a manner that, when the first deformation path is exceeded, the inner profile element comes into contact with the outer profile element substantially in the center of the end plate and increases the rigidity of said end plate and applies the second bias, which is greater compared with the first bias, to the battery cells.

Through the “engagement” of the outer profile element once the first deformation path is exceeded, a different, in particular greater, rigidity of the end plate can therefore be achieved. This engagement has the effect that, depending on the expansion, the bias on the battery cells behaves according to a different ratio. In other words, the bias changes depending on the expansion of the battery cells within the first deformation path along a first bias-expansion curve. Once the first deformation path is exceeded, i.e. for a second deformation path, the bias changes along a second bias/expansion curve as a function of the expansion of the battery cells within the second deformation path.This is advantageous since, from the passing-through of the first deformation path, the second bias curve can be increased disproportionately to the battery cells by comparison with the first deformation path, depending on the expansion within the first deformation path, which improves or increases the mode of operation and the life of the battery module.

According to a further embodiment, the inner profile element has a first modulus of elasticity and the outer profile element has a second modulus of elasticity, wherein the first modulus of elasticity of the inner profile element sets the desired bias on the battery cells within the first deformation path. The first modulus of elasticity of the inner profile element combined with the second modulus of elasticity determines the desired bias on the battery cells within a second deformation path, i.e. outside the first deformation path.

By selection of the modulus of elasticity of the inner and the outer profile element, a wide variety of bias curves can therefore be configured with respect to the expansion. In one example, the first modulus of elasticity may be smaller than the second modulus of elasticity. In another example, the first modulus of elasticity and the second modulus of elasticity may be equal.

Depending on the battery module configuration, the resulting swelling forces may be different, so that the expansion of the battery cells may be different. The inner profile element and the outer profile element may be adjusted by means of the end plate proposed here via their modulus of elasticity, in such a manner as to correspond to the different requirements of the battery module configurations.

According to one embodiment, the inner profile element and/or the outer profile element can be adapted to different battery module configurations and/or desired biases by adapting the modulus of elasticity of the inner profile element and of the outer profile element, in particular by adapting the wall thicknesses and/or the material and/or the size of the first deformation path and/or the shape.

In one example, the expansion of the first deformation path can be adjusted via the shape of the inner profile element. In another example, the rigidity can be increased by means of a change in the wall thicknesses and the bias curve can therefore be adapted depending on the expansion.

These kinds of design adjustment possibilities of the shape and of the configuration of the profile elements are advantageous since they allow a rapid, flexible and simple adjustment to different battery configurations with different requirements of the bias or expansion.

According to one embodiment, the inner profile element and/or the outer profile element are roll-profiled sheet metal plates.

The shaping and configuration of the inner and outer profile elements by profile rolling is advantageous, since in this way the inner and outer profile elements can be designed to be quick, flexible, reliable and cost-effective. In addition, high unit numbers can be provided cost-effectively.

The outer profile element is preferably formed in one piece, and particularly preferably in the form of a leaf spring. As a result of this, a first desired bias curve can be defined as a function of the expansion of the battery cells. In this case, the leaf spring is configured so as to apply a bias to the battery cells in the initial state and to guarantee expansion during the course of the operation of the battery module, wherein the battery cells are further clamped by the outer profile element. A second bias curve is therefore defined within the second a deformation path as a function of the expansion of the battery cells by the leaf spring.

According to a further embodiment, the inner profile element is formed in one piece and as an arcuate or U-shaped structure. As a result, a stiffer profile element, i.e. one with a higher modulus of elasticity, is provided. Within the first deformation path, a first bias curve is defined by the engagement of the inner profile element, depending on the expansion of the battery cells.

According to a further embodiment, an outer side of the inner profile element is sectionally connected to an inner side of the outer profile element, wherein the inner profile element partially encloses the outer profile element, and wherein the outer side of the outer profile element is the outer side of the housing.

According to a further embodiment, the inner profile element and the outer profile element are connected to one another by a material-bonded or force-fit connection. As a result of this, the at least one end plate can be formed without further fastening elements from the inner profile element and the outer profile element.

According to a further embodiment, the housing is substantially adapted to the installation space for receiving a plurality of battery cells.

According to a further embodiment, the housing has two substantially perpendicular side walls with respect to the end plates.

The end plates may be connected to the side walls via a force-fit connection, e.g. snap & click or screw connections. This has the advantage that the housing can be assembled according to a modular principle depending on the battery module configuration.For example, depending on the number and size of the battery cells used in a battery module, housings with different side wall lengths with different end plate widths can be formed. Consequently, different housing interior volumes can be assembled quickly and easily.

In a further example, the housing may have a substantially planar underside, wherein the plane of the underside is perpendicular to the plane of the side walls and perpendicular to the plane of the end plate, and thus forms the housing interior downwardly.

In a further example, the housing may have a substantially planar upper side, wherein the plane of the upper side is perpendicular to the plane of the side walls and perpendicular to the plane of the end plate, and therefore covers the housing interior upwardly.

According to a further aspect, a traction battery for a motor vehicle is proposed, comprising at least one battery module with the housing described above.

By means of the flexibly insertable housing described above, traction batteries with different specifications and for different applications can be formed in a flexible and efficient manner.

According to one embodiment, the at least one battery module is connected to a vehicle structure via the housing.

In one example, attachment regions are integrated in the housing, in order to attach the battery module to the vehicle structure. In this way, battery modules can also be provided preassembled, so that the construction of the traction battery can be carried out efficiently and locally and spread over a longer period of time. Furthermore, an efficient and reliable assembly of a traction battery from battery modules can thereby be achieved.

### BRIEF DESCRIPTION OF THE FIGURES

Preferred further embodiments of the invention are explained in greater detail by the following description of the figures. In the drawings:

FIG. 1 shows a schematic view of a housing for a battery module for receiving battery cells which are clamped between two opposite end plates of a housing according to one exemplary embodiment,

FIG. 2 shows a schematic sectional view of an end plate according to an embodiment;

FIG. 3 shows a schematic perspective view of the end plate from FIG. 2 according to an exemplary embodiment; and

FIG. 4 shows an exemplary exponential voltage curve as a function of the expansion of the battery cells according to an embodiment.

### DETAILED DESCRIPTION OF PREFERRED EXEMPLARY EMBODIMENTS

Preferred exemplary embodiments are described below with reference to the figures. In this case, elements which are identical, similar, or produce the same effect are provided with identical reference symbols in the different figures, and a repeated description of these elements is dispensed with in some cases, in order to avoid duplication.

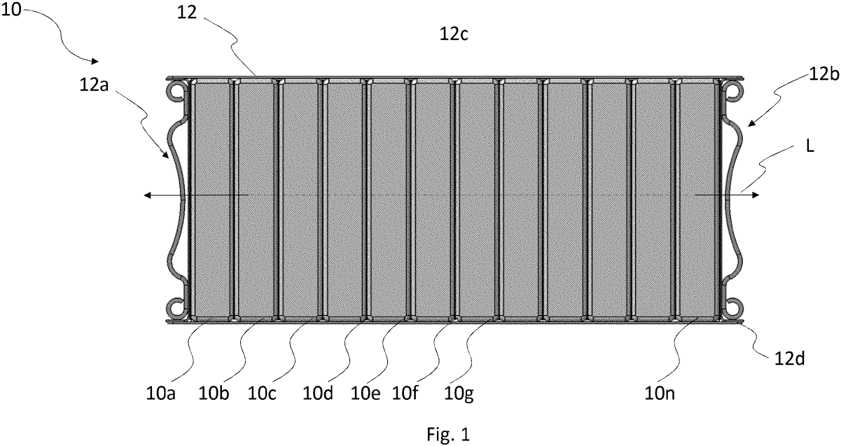

FIG. 1 schematically shows a housing 12 for a battery module 10 for receiving battery cells 10a-n. The plurality of battery cells 10a-n can be arranged within the housing 12 next to one another along a longitudinal direction L of the housing.

Accordingly, the battery cells 10a-n may preferably be prismatic cells or pouch cells, which enable a particularly space-saving, and therefore efficient, construction of the battery module 10.

Prismatic cells usually have a solid cubic housing, whereas pouch cells are usually enclosed in a flexible metal foil.

As shown by way of example here, the housing 12 comprises at least one end plate, in this case two end plates 12a, 12b lying opposite one another, between which the battery cells 10a-n are arranged.

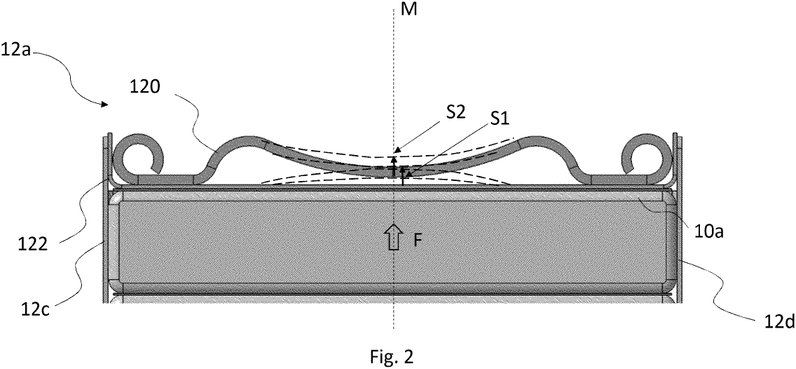

In the exemplary embodiment shown, each of the end plates 12a, 12b comprises an inner profile element 122 and an outer profile element 120 (see FIG. 2). The end plates 12a, 12b are configured in such a manner that they meet with an expansion of the battery cells 10a-n perpendicular to the plane formed by the end plates 12a, 12b, i.e. in the longitudinal direction of the housing L (see arrows along the longitudinal direction L).

The housing 12 is preferably substantially adapted to the installation space for receiving a plurality of battery cells 10a-n. In this case, the housing 12 has at least two substantially perpendicular side walls 12c, 12d with respect to the end plates 12a, 12b.

As shown in the sectional depiction of an end plate 12a in FIG. 2, the inner profile element 122 is formed and designed in such a way that, within a first deformation path S1, it exerts a first elastic bias (see arrows) on battery cells 10a-n arranged in the housing 12, in this case, for example, on the battery cell 10a arranged on the end plate 12a.

As shown by way of example, an inner side of the outer profile element 120 is in press contact with an outer side of a battery cell via the inner profile element 122, i.e. in an initial state, the outer profile element 120 is arranged in such a manner that a bias acts directly and/or indirectly on the battery cells 10a-n, in this case directly via the battery cell 10a.

The inner profile element 122 and the outer profile element 120 are formed and designed in such a way that, when the first deformation path S1 is exceeded, the inner profile element 122 interacts with the outer profile element 120 in order to exert a second elastic bias on battery cells 10a-n arranged in the housing 12.

By means of the two-part solution made up of the inner profile element 122 and the outer profile element 120 of the at least one end plate 12a, 12b, the rigidity of the end plate, and therefore a desired bias on the battery cells, can be better adjusted depending on a desired expansion of the battery cells. Until a first deformation path S1 is reached (as indicated by a dashed region of the inner profile element), the elastic bias is controlled via the inner profile element 122. Once the first deformation path S1 is exceeded, the inner profile element 122 comes into contact with the outer profile element 120 substantially in the center thereof, so that the inner profile element 122 interacts with the outer profile element 120 over the further deformation path and correspondingly provides a combined bias. In this way, the bias exerted on the battery cells 10a-n may have a lower value within the first deformation path S1 than the bias which is exerted on the battery cells 10a-n when the first deformation path S1 is exceeded.

In other words, the inner profile element 122 and the outer profile element 120 interact in such a manner that the rigidity is increased after the first deformation path S1 is exceeded. The expansion of the battery cells, and the bias acting on the battery cells as a result, are therefore controlled in an optimized manner in two stages, at least by the two-part solution. In other words, the battery cells can expand while maintaining a bias. In this way, the functioning of the battery cells is improved and the life of the battery module increased.

In other words, the battery cells can expand, wherein a desired bias constantly acts on the battery cells, in order to improve the functioning of the battery cells and increase the life thereof.

As shown in FIG. 2, the inner profile element 122 and the outer profile element 120 can interact in such a way that once the first deformation path S1 is exceeded (as also indicated by the dashed region of the inner profile element in FIG. 2), the inner profile element 122 comes into contact with the outer profile element 120 substantially in the center of the end plate 12a.

After making contact, the profile elements 120, 122 interact and thereby increase the rigidity of the end plate 12a. As a result, a second bias, which is increased with respect to the first bias, is applied to the battery cells 10a. At the same time, the expansion along a second deformation path S2 (as also indicated by the dashed region of the outer profile element 120) is determined via the combination of the inner profile element 122 and the outer profile element 120.

The inner profile element 122 preferably has a first modulus of elasticity and the outer profile element 120 has a second modulus of elasticity, wherein the first modulus of elasticity of the inner profile element 122 sets the desired bias on the battery cells 10a -10n within the first deformation path S1, and wherein the first modulus of elasticity of the outer profile element 120 in combination with the second modulus of elasticity of the inner profile element 122 sets the desired bias on the battery cells 10a -10n within the second deformation path S2.

In an exemplary embodiment shown in FIG. 2, the outer profile element 120 is formed in one piece and virtually in the form of a leaf spring. In this case, the outer profile element 122 has two elevations which are arranged mirror-symmetrically with respect to a center line M of the end plate 12a.

Furthermore, by way of example, the outer profile element 120 is crimped on the outer sides. The crimping produces a more rigid construction.

Furthermore, as in an exemplary embodiment shown in FIG. 2, the inner profile element 122 may be formed in one piece and configured as an arcuate or U-shaped structure. This provides a more rigid structure with respect to the outer profile element 120, i.e. a structure with a higher modulus of elasticity. Within the first deformation path, a first bias curve is thereby defined as a function of the expansion of the battery cells through the engagement of the inner profile element 122.

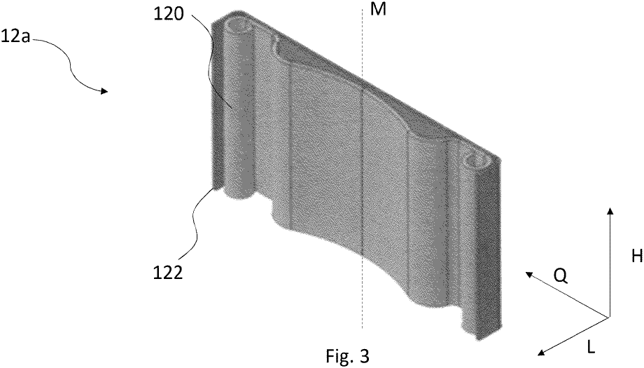

FIG. 3 shows the at least one end plate 12a and the inner profile element 122 and the outer profile element 120 in a partially sectional perspective view. In this case, the inner profile element 122 and the outer profile element 120 are shown as roll-profiled sheet-metal plates which extend in a vertical direction H and a transverse direction Q of the end plate 12, which substantially corresponds to the height of the battery cells 10a-n, in order to clamp said battery cells 10a-n in the longitudinal direction L of the housing or of the battery module 10.

In this case, the inner profile element 122 and/or the outer profile element 120 can be adapted to different battery module configurations and/or desired biases by adapting the modulus of elasticity of the inner profile element 122 and of the outer profile element 120, in particular by adapting the wall thicknesses and/or the material and/or the size of the first deformation path S1, S2 and/or the shape.

As shown by way of example in FIGS. 2 and 3, an outer side of the inner profile element 122 is partially connected to an inner side of the outer profile element 120, wherein the inner profile element 122 encloses the outer profile element 120, and wherein the outer side of the outer profile element 120 is, or forms, the outer side of the housing 12.

The inner profile element 122 and the outer profile element 120 are preferably connected to one another by a material-bonded or force-fit connection.

The proposed housing 12 for receiving a plurality of battery cells 10a-n forms the battery module 10.

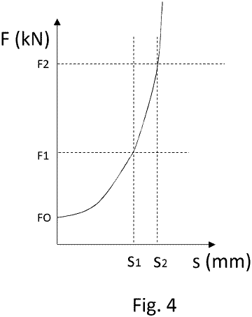

FIG. 4 shows, by way of example, the curve of the bias F over the deformation path S, and therefore also over the deformation or expansion of the battery cells.

In the initial state, the battery cells may be clamped with a bias F0. The battery cells expand during operation. The inner profile element 122 guarantees an expansion of the battery cells with a first bias within a first deformation path S1 of the battery cells. In this case, the bias exerted on the battery cells is controlled only via the inner profile element 122 within the first deformation path S1.

When the end of the first deformation path S1 is reached, a force F1 which is greater than F0 is exerted on the battery cells by the inner profile element 122. After the first deformation path S1 is exceeded, the curve of the bias F is determined via the cooperation of the inner profile element 122 and the outer profile element 120.

For example, the inner profile member 122 and the outer profile member 120 jointly produce a bias F2 that is greater than F1 on the battery cells. Beyond S2, the bias exerted by the inner and outer profile element is so great that a further expansion of the battery cells is scarcely possible.

Due to the “engagement” of the outer profile element 120 once the first deformation path S1 is exceeded, a different, in particular greater, rigidity of the end plate 12a can therefore be achieved.

This engagement has the effect that the bias on the battery cells behaves depending on the expansion according to a modified ratio. In other words, the bias changes as a function of the expansion of the battery cells within the first deformation path along a first bias (F)/expansion (S) curve.

Once the first deformation path S1 is exceeded, i.e. for a second deformation path S2, the bias changes depending on the expansion of the battery cells within the second deformation path S2 along a second bias/expansion curve.This is advantageous since, from the passing-through of the first deformation path S1, the second bias curve (F1 to F2) on the battery cells can be increased disproportionately by comparison with the first bias curve (F0-F1) as a function of the expansion within the first deformation path, which improves or increases the functionality and life of the battery module.

As shown in FIG. 4, the inner profile element 122 and the outer profile element 120 can therefore be formed and configured in such a way that the bias F on the battery cells with respect to the deformation path S or the expansion runs along a non-linear, preferably exponential function. As a result of the two-part design of the end plate, i.e. with an inner profile element 122 and an outer profile element 120, other bias profiles can also be configured alternatively.

According to an aspect which is not shown, a traction battery for a motor vehicle may have at least one battery module with a housing 12 of this kind for receiving battery cells.

Insofar as applicable, all individual features illustrated in the exemplary embodiments can be combined and/or exchanged with one another without departing from the scope of the invention.

List of reference signs

| | |
|---|---|
| 10 | battery module |
| 10a-n | battery cells |
| 12 | housing |
| 12a, 12b | end plate |
| 12c, 12d | side wall |
| 120 | outer profile element |
| 122 | inner profile element |
| S1 | first deformation path |
| S2 | second deformation path |
| F | bias |

1. A housing for a battery module for receiving battery cells, comprising: at least one end plate containing an inner profile element and an outer profile element, wherein the inner profile element is formed and designed such that, within a first deformation path, the inner profile element provides a first elastic bias on battery cells arranged in the housing, and wherein the inner profile element and the outer profile element are formed and designed such that, once the first deformation path is exceeded, the inner profile element interacts with the outer profile element to exert a second elastic bias on battery cells arranged in the housing.

2. The housing as claimed in claim 1, wherein the inner profile element and the outer profile element interact with one another in such a manner that once the first deformation path is exceeded, the inner profile element comes into contact with the outer profile element.

3. The housing as claimed in claim 2, wherein the inner profile element comes into contact with the outer profile element substantially in the center thereof.

4. The housing as claimed in claim 3, wherein the inner profile element has a first modulus of elasticity and the outer profile element has a second modulus of elasticity, wherein the first modulus of elasticity of the inner profile element sets the first elastic bias on the battery cells within the first deformation path, and wherein the first modulus of elasticity of the inner profile element, combined with the second modulus of elasticity, sets a second elastic bias on the battery cells within a second deformation path.

5. The housing as claimed in claim 4, wherein at least one of: the inner profile element and the outer profile element are adapted to at least one of: different battery module configurations and desired biases by adapting the modulus of elasticity of the inner profile element and of the outer profile element.

6. The housing as claimed in claim 5, wherein at least one of: the inner profile element and the outer profile element are roll-profiled sheet metal plates.

7. The housing as claimed in claim 6, wherein the outer profile element is formed in one piece.

8. The housing as claimed in claim 7, wherein the inner profile element is formed in one piece.

9. The housing as claimed in claim 8, wherein an inner side of the outer profile element is sectionally connected to an outer side of the inner profile element.

10. The housing as claimed in claim 9, wherein the outer side of the outer profile element is the outer side of the housing.

11. The housing as claimed in claim 10, wherein the inner profile element and the outer profile element are sectionally connected to one another by at least one of: a material-bonded connection and a force-fit connection.

12. The housing as claimed in claim 11, wherein at least two opposite end plates each comprising an inner profile element and an outer profile element are provided, and wherein the end plates exert an elastic bias on battery cells arranged therebetween.

13. The housing as claimed in claim 12, wherein the housing has two substantially perpendicular side walls with respect to the end plates.

14. A battery module with a housing, the housing comprising: at least one end plate containing an inner profile element and an outer profile element, wherein the inner profile element is formed and designed such that, within a first deformation path, the inner profile element provides a first elastic bias on battery cells arranged in the housing, and wherein the inner profile element and the outer profile element are formed and designed such that, once the first deformation path is exceeded, the inner profile element interacts with the outer profile element to exert a second elastic bias on battery cells arranged in the housing; and at least one battery cell operatively connected to the inner profile element.

15. The battery module of claim 14, wherein the at least one battery cell is at least one of: a prismatic cell and a pouch cell.

16. The housing as claimed in claim 5, wherein at least one of: the inner profile element and the outer profile element are adapted to at least one of: different battery module configurations and desired biases by adapting the modulus of elasticity of the inner profile element and of the outer profile element by adapting at least one of: the wall thicknesses, the material, and the shape.

17. The housing as claimed in claim 7, wherein the outer profile element is formed in the form of a leaf spring.

18. The housing as claimed in claim 8, wherein the inner profile element is formed as at least one of: an arcuate structure and a U-shaped structure.

19. The housing as claimed in claim 9, wherein the inner profile element partially encloses the outer profile element.
